(19) United States
(12) Patent Application Publication
(10) Pub. No.: US 2016/0284437 A1
(43) Pub. Date: Sep. 29, 2016

(54) COPPER ALLOY WIRE, COPPER ALLOY STRANDED WIRE, ELECTRIC WIRE, TERMINAL-FITTED ELECTRIC WIRE, AND METHOD OF MANUFACTURING COPPER ALLOY WIRE

(71) Applicants: Sumitomo Electric Industries, Ltd., Osaka-shi (JP); AutoNetworks Technologies, Ltd., Yokkaichi (JP); Sumitomo Wiring Systems, Ltd., Yokkaichi (JP)

(72) Inventors: Akiko Inoue, Osaka-shi (JP); Tetsuya Kuwabara, Osaka-shi (JP); Yoshihiro Nakai, Osaka-shi (JP); Taichiro Nishikawa, Osaka-shi (JP); Hiroyuki Kobayashi, Yokkaichi (JP)

(21) Appl. No.: 15/037,623

(22) PCT Filed: Dec. 5, 2014
(86) PCT No.: PCT/JP2014/082233

§ 371 Date: May 18, 2016

(30) Foreign Application Priority Data
Dec. 19, 2013 (JP) 2013-262232

(51) Int. Cl. H01B 7/00; H01R 4/18; B22D 21/00; H01B 13/00; C22C 9/00; C22F 1/08

(52) U.S. Cl. CPC H01B 7/0036; C22C 9/00; C22F 1/08; B22D 21/005; H01B 13/0036; H01B 13/0016; H01R 4/185

(57) ABSTRACT

Provided are: a copper alloy wire having an excellent electrical conductivity, a high strength, and an excellent elongation; a copper alloy stranded wire including the copper alloy wire; an electric wire including the copper alloy wire or the copper alloy stranded wire as a conductor; a terminal-fitted electric wire including the aforementioned electric wire; and a method of manufacturing a copper alloy wire. The copper alloy wire has a composition including: not less than 0.2% by mass and not more than 1% by mass of Mg; not less than 0.02% by mass and not more than 0.1% by mass of P; and the balance including Cu and inevitable impurities. The copper alloy wire has an electrical conductivity of not less than 60% IACS, a tensile strength of not less than 400 MPa, and an elongation at breakage of not less than 5%.

### TECHNICAL FIELD

The present invention relates to: a copper alloy wire and a copper alloy stranded wire which are each used as a conductor of an electric wire or the like; an electric wire which includes the copper alloy wire or the copper alloy stranded wire as a conductor; a terminal-fitted electric wire which includes the aforementioned electric wire; and a method of manufacturing a copper alloy wire. The present invention particularly relates to a copper alloy wire which is excellent in electrical conductivity, has a high strength, and is also excellent in elongation.

### BACKGROUND ART

Conventionally, as a material for a conductor of an electric wire, pure copper or copper alloy having a high electrical conductivity is used. Japanese Patent Laying-Open No. 2008-016284 (PTD 1) discloses a stranded wire as a conductor of an electric wire for an automobile. The disclosed stranded wire is made up of stranded hard constituent wires of a binary alloy such as Cu—Mg alloy or Cu—Sn alloy. Japanese Patent Laying-Open No. 2008-016284 (PTD 1) also discloses that: the aforementioned hard constituent wires have a high tensile strength and therefore the stranded wire is less likely to be broken; in the case where the electric wire for an automobile is used with a terminal press-fit to the conductor at an end of the electric wire, the strength of fixing the terminal to the conductor (terminal-fixing strength) is excellent; and the electric wire is less likely to buckle when the terminal attached to the electric wire is inserted in a connector housing.

Japanese Patent Laying-Open No. 58-197242 (PTD 2) discloses a copper alloy wire as an electrode wire for discharging machining that includes Mg and P, and Sn, or the like each having a content falling in a specific range.

### CITATION LIST

### Patent Document

### PTD 1: Japanese Patent Laying-Open No. 2008-016284

### PTD 2: Japanese Patent Laying-Open No. 58-197242

### SUMMARY OF INVENTION

### Technical Problem

It is desired to develop a copper alloy wire which is to be used as a wire forming a conductor of an electric wire, has an excellent electrical conductivity and a high strength, and is also excellent in flexural property and impact resistance. In particular, a wire forming a conductor of an electric wire used in an automobile is desired to have a small diameter for example of 0.3 mm or less for the sake of reducing the weight. It is desired to develop a copper alloy wire which has such a small diameter and still has a high electrical conductivity, specifically an electrical conductivity of not less than 60% IACS, and a high strength, specifically a tensile strength of not less than 400 MPa, and is also resistant to flexure and impact and exemplarily excellent in elongation as well.

The stranded wire disclosed in Japanese Patent Laying-Open No. 2008-016284 (PTD 1) satisfies both the required range of the electrical conductivity and the required range of the tensile strength as described above. However, this is excessively hard and thus low in toughness. In the case for example where the wire is bent when routed or is subjected to impact when the terminal is inserted in a connector housing, for example, cracks may occur or the wire may be broken. On the contrary, a soft material produced through softening for the sake of ensuring flexibility is too soft and is thus low in strength.

Although Japanese Patent Laying-Open No. 58-197242 (PTD 2) discloses that coexistence of Mg and P improves the strength, it fails to specifically disclose the tensile strength. Moreover, according to Japanese Patent Laying-Open No. 58-197242 (PTD 2), a structure which is excellent not only in strength but also flexure and impact and a method of manufacturing the same are not studied.

Thus, an object of the present invention is to provide a copper alloy wire which is excellent in electrical conductivity, has a high strength, and is also excellent in elongation, as well as a method of manufacturing such a copper alloy wire. Another object of the present invention is to provide a copper alloy stranded wire including the aforementioned copper alloy wire, an electric wire including the aforementioned copper alloy wire or the aforementioned copper alloy stranded wire, and a terminal-fitted electric wire including the aforementioned electric wire.

### Solution to Problem

A copper alloy wire of the present invention has a composition including: not less than 0.2% by mass and not more than 1% by mass of Mg; not less than 0.02% by mass and not more than 0.1% by mass of P; and the balance including Cu and inevitable impurities, the copper alloy wire has an electrical conductivity of not less than 60% IACS, a tensile strength of not less than 400 MPa, and an elongation at breakage of not less than 5%.

A method of manufacturing a copper alloy wire of the present invention includes a solid solution step, a precipitation step, and a working step as follows.

Solid Solution Step: a step of preparing a solid solution material having a composition including: not less than 0.2% by mass and not more than 1% by mass of Mg; not less than 0.02% by mass and not more than 0.1% by mass of P; and the balance including Cu and inevitable impurities, the Mg and the P being dissolved in the Cu in the solid solution material.

Precipitation Step: a step of heating the solid solution material to produce an aged material having a structure in which a compound containing the Mg and the P is dispersed in a matrix.

Working step: a step of wiredrawing the aged material in a plurality of passes to produce a wiredrawn material having a predetermined final wire diameter, an electrical conductivity of not less than 60% IACS, and a tensile strength of not less than 400 MPa.

In the working step, an intermediate softening treatment is performed on an intermediate material having an intermediate wire diameter of more than one time and not more than ten times as large as the final wire diameter.

### Advantageous Effects of Invention

The copper alloy wire of the present invention has a high electrical conductivity and a high strength, and is also excellent in elongation. The method of manufacturing a copper alloy wire of the present invention can be used to manufacture a copper alloy wire which has a high electrical conductivity and a high strength, and is also excellent in elongation.

### BRIEF DESCRIPTION OF DRAWINGS

FIG. 1 shows a photomicrograph of a cross section of an aged material of Sample Nos. 1 to 3 prepared for Test Example 1.

FIG. 2 is a schematic structure diagram schematically showing a cross section of a copper alloy stranded wire in an embodiment.

FIG. 3 is a schematic structure diagram schematically showing a cross section of an electric wire in an embodiment.

FIG. 4 is a schematic structure diagram schematically showing a terminal-fitted electric wire in an embodiment.

FIG. 5 is a flowchart showing an example of steps for manufacturing a copper alloy wire in an embodiment.

FIG. 6 is a flowchart showing an example of steps for manufacturing a copper alloy stranded wire in an embodiment.

### DESCRIPTION OF EMBODIMENTS

### Description of Embodiments of the Invention

According to the results of studies conducted by the inventors of the present invention, it has been found that a copper alloy wire which is excellent in electrical conductivity, has a high strength, and is also excellent in elongation is obtained by defining a specific range of the content of Mg (magnesium) and a specific range of the content of P (phosphorus) and, in a manufacturing process, (i) promoting precipitation of a compound containing Mg and P so that extremely fine precipitates are generated, and (ii) performing a softening treatment at a specific timing during wiredrawing. The present invention is based on the above finding. First, details of embodiments of the present invention will be described one by one.

(1) A copper alloy wire according to an embodiment has a composition including: not less than 0.2% by mass and not more than 1% by mass of Mg; not less than 0.02% by mass and not more than 0.1% by mass of P; and the balance including Cu and inevitable impurities, the copper alloy wire has an electrical conductivity of not less than 60% IACS, a tensile strength of not less than 400 MPa, and an elongation at breakage of not less than 5%.

The copper alloy wire of the embodiment has the specific composition including Mg and P each falling in the specific range. The copper alloy wire is therefore excellent in electrical conductivity, has a high strength, and is also excellent in elongation. For example, even when the wire has a small diameter for example of 0.3 mm or less, the wire can meet the aforementioned ranges of the electrical conductivity, the tensile strength, and the elongation at breakage. Accordingly, the copper alloy wire of the embodiment can suitably be used for an electric wire which is desired to have a small diameter for the sake of reducing the weight, specifically used as a conductor of an electric wire for an automobile.

In the case where the copper alloy wire of the embodiment is used as a conductor of an electric wire for an automobile, the high strength of the copper alloy wire produces the following effects (i) and (ii), and the high toughness thereof produces the following effect (iii).

(i) The state of connection between the conductor and a terminal attached to an end of the conductor can be maintained satisfactorily from the beginning to the end of use. Namely, a high terminal-fixing strength can be kept over a long time.

(ii) Breakage due to repeated bending resultant from vibrations of an automobile is less likely to occur, namely the fatigue resistance is excellent.

(iii) Cracks and breakage are less likely to occur even when the wire is bent or impacted during wire routing or insertion of a terminal into a connector housing, namely the flexural property and the impact resistance are excellent.

(2) As an example of the copper alloy wire according to the embodiment, the copper alloy wire may be of the form in which the copper alloy wire has a structure in which a precipitate disperses, the precipitate includes a compound containing the Mg and the P, and the precipitate has an average particle size of not more than 500 nm.

In this form, the copper alloy wire has the structure in which Mg and P are present in the state of extremely fine precipitates and these fine precipitates are dispersed. Therefore, this form produces the effect of improving the strength through strengthening by dispersion of the fine precipitates (precipitation strengthening), in addition to solid solution strengthening by solid solution of Mg, and work-hardening-based strengthening by wiredrawing which is performed in the process of manufacturing a wire. Namely, this form exhibits an excellent strength through a combination of the three phenomena, namely solid solution strengthening, work hardening, and dispersion strengthening. Moreover, the fact that the precipitates are extremely fine makes it less likely that a precipitate acts as an origin of a crack. Therefore, this form is excellent not only in strength but also in elongation. Further, precipitation of Mg and P can reduce excessive solution of Mg in Cu, and therefore, this form is excellent in electrical conductivity.

(3) As an example of the copper alloy wire according to the embodiment, the copper alloy wire may be of the form in which the copper alloy wire further includes, in addition to the composition, not less than 0.01% by mass and not more than 0.5% by mass in total of at least one element selected from Fe (iron), Sn (tin), Ag (silver), In (indium), Sr (strontium), Zn (zinc), Ni (nickel), and Al (aluminum).

In this form, increase of the strength is facilitated by the fact that the copper alloy wire contains the above-listed elements.

(4) As an example of the copper alloy wire according to the embodiment, the copper alloy wire may be of the form in which a mass ratio Mg/P of the Mg to the P is not less than 4 and not more than 30.

P contributes to precipitation of Mg. A higher content of P causes more precipitation of Mg. In this form, the content of Mg relative to the content of P is appropriately adjusted, and therefore, appropriate precipitation of the compound containing Mg and P as well as suppression of excessive precipitation of Mg can be achieved. Consequently, in this form, the solid-solution strengthening effect of Mg is obtained, deterioration of the workability due to excessive precipitation can be suppressed, and wiredrawing can satisfactorily be performed. Therefore, the productivity of the copper alloy wire is excellent.

(5) As an example of the copper alloy wire according to the present embodiment, the copper alloy wire may be of the form in which the copper alloy wire has a wire diameter of not more than 0.35 mm. As to the wire diameter, in the case of a round wire having a circular cross section, the wire diameter is the diameter and, in the case of a deformed wire having a cross sectional shape other than a circular shape, the wire diameter is the diameter of a circle corresponding to the area of the cross section.

In this form, the wire has a small diameter and can therefore be used as a conductor of an electric wire for which weight reduction is desired, particularly a conductor of an electric wire for an automobile.

(6) As an example of the copper alloy wire according to the embodiment, the copper alloy wire may be of the form in which an average particle size of a matrix including the Cu is not more than 10 μm.

In this form, the copper alloy wire is excellent in elongation, and the terminal-fixing strength of the copper alloy wire can further be increased.

(7) A copper alloy stranded wire according to an embodiment includes a copper alloy wire of the embodiment described under any one of (1) to (6) above.

The copper alloy stranded wire of the embodiment includes at least one copper alloy wire of the embodiment that is excellent in electrical conductivity, has a high strength, and is also excellent in elongation. The copper alloy stranded wire is accordingly excellent in electrical conductivity, has a high strength, and is also excellent in elongation. In the case where all constituent wires of the copper alloy stranded wire of the embodiment are the copper alloy wires of the embodiment, easy stranding and high productivity are achieved in addition to the excellent electrical conductivity, strength, and toughness.

(8) A copper alloy stranded wire of an embodiment is a compression-molded stranded wire which includes a copper alloy wire of the embodiment described under any one of (1) to (6) above (this copper alloy stranded wire may be referred to as compressed wire hereinafter).

Like the copper alloy stranded wire of the embodiment described above under (7), the compressed wire of the embodiment includes at least one copper alloy wire of the embodiment that is excellent in electrical conductivity, has a high strength, and is also excellent in elongation. The compressed wire is accordingly excellent in electrical conductivity, has a high strength, is also excellent in elongation, and is further excellent in productivity. In particular, the compressed wire of the embodiment also produces the effects that the stranded state is stable and thus the compressed wire is easy to handle, and the wire diameter (the diameter of the envelope circle of the stranded wire) can be reduced and thus a still smaller diameter can be achieved.

(9) As an example of the copper alloy stranded wire according to the embodiment, the copper alloy stranded wire may be of the form in which the copper alloy stranded wire has a cross-sectional area of not less than 0.05 mm² and not more than 0.5 mm².

In this form, the cross-sectional area is small. Therefore, the copper alloy stranded wire can suitably be used as a conductor of an electric wire for which weight reduction is desired, particularly as a conductor of an electric wire for an automobile.

(10) As an example of the copper alloy stranded wire according to the embodiment, the copper alloy stranded wire may be of the form in which the copper alloy wire has a twist pitch of not less than 10 mm and not more than 20 mm.

The twist pitch of not less than 10 mm can improve the productivity of the copper alloy stranded wire. The twist pitch of not more than 20 mm can improve the flexibility of the copper alloy stranded wire.

(11) An electric wire according to an embodiment includes a conductor and an insulating layer covering a surface of the conductor, and the conductor is a copper alloy wire of the embodiment described under any one of (1) to (6) above, or a copper alloy stranded wire of the embodiment described under any one of (7) to (10) above.

The electric wire of the embodiment includes, as its conductor, the copper alloy wire of the embodiment that is excellent in electrical conductivity, has a high strength, and is also excellent in elongation. Preferably, all wires forming the conductor are each the copper alloy wire of the embodiment. Accordingly, the electric wire is excellent in electrical conductivity, has a high strength, and is also excellent in elongation. Such an electric wire of the embodiment can be expected to produce the following effects (1) to (4) in the case where the electric wire having one end to which a terminal is attached is used as an electric wire for an automobile. (1) The conductor is less likely to be broken even when bent for routing for example. (2) The conductor is less likely to be broken even under impact when the terminal is connected to the connector housing. (3) The state of connection between the conductor and the terminal is less likely to be loosened even under vibration in use. (4) The conductor is less likely to be broken even in the presence of fatigue due to vibration or the like. Namely, the electric wire of the embodiment is excellent in impact resistance, has a high terminal-fixing strength, and excellent fatigue resistance and flexural property, and can suitably be used for wiring for an automobile.

(12) A terminal-fitted electric wire according to an embodiment includes an electric wire of the above-described embodiment and a terminal portion attached to an end of the electric wire.

The terminal-fitted electric wire of the embodiment includes the electric wire of the embodiment that is excellent in electrical conductivity, has a high strength, and is also excellent in elongation. The terminal-fitted electric wire is thus excellent in electrical conductivity, has a high strength, and is also excellent in elongation. Therefore, in the case where the terminal-fitted electric wire of the embodiment is used for wiring for an automobile for example, the following effects (1) to (4) can be expected. (1) The conductor is less likely to be broken even when bent for routing for example. (2) The conductor is less likely to be broken even under impact when the terminal is connected to a connector housing. (3) The state of connection between the conductor and the terminal is less likely to be loosened even under vibration in use. (4) The conductor is less likely to be broken even in the presence of fatigue due to vibration or the like. Namely, the terminal-fitted electric wire of the embodiment is excellent in impact resistance, and has a high terminal-fixing strength, excellent fatigue resistance, and flexural property, and can suitably be used for wiring for an automobile.

(13) A method of manufacturing a copper alloy wire according to an embodiment includes a solid solution step, a precipitation step, and a working step as follows.

Solid Solution Step: the step of preparing a solid solution material having a composition comprising: not less than 0.2% by mass and not more than 1% by mass of Mg; not less than 0.02% by mass and not more than 0.1% by mass of P; and the balance including Cu and inevitable impurities, the Mg and the P being dissolved in the Cu in the solid solution material.

Precipitation Step: the step of heating the solid solution material to produce an aged material having a structure in which a compound containing the Mg and the P is dispersed in a matrix.

Working step: the step of wiredrawing the aged material in a plurality of passes to produce a wiredrawn material having a predetermined final wire diameter, an electrical conductivity of not less than 60% IACS, and a tensile strength of not less than 400 MPa.

In the working step, an intermediate softening treatment is performed on an intermediate material having an intermediate wire diameter of more than one time and not more than ten times as large as the final wire diameter.

The method of manufacturing a copper alloy wire of the embodiment can be used to manufacture a copper alloy wire which is excellent in electrical conductivity, has a high strength, and is also excellent in elongation, and typically has an electrical conductivity of not less than 60% IACS, a tensile strength of not less than 400 MPa, and an elongation at breakage of not less than 5%, for the reasons below.

The method of manufacturing a copper alloy wire of the embodiment includes the steps in which a solid solution of Mg and P in Cu is prepared first, then heating corresponding to aging (heating may not be aging) is performed to promote precipitation of a part of Mg from Cu in the solid solution, making use of the effect of P of promoting precipitation of Mg, and thereafter wiredrawing is performed. Namely, a precipitate (typically a compound containing Mg and P) is precipitated from the solid solution, and it is therefore easy to control the state of precipitation (such as the size of the precipitate, the degree of dispersion of the precipitate). Thus, extremely fine precipitates can be obtained and the fine precipitates can uniformly be dispersed in the matrix. It is considered that consequently the effect of improving the strength can be obtained through solid solution strengthening by the balance of Mg and dispersion strengthening through dispersion of fine precipitates (precipitation strengthening).

The aged material having the specific structure as described above is subjected to wiredrawing in a plurality of passes, and intermediate softening treatment is performed at a specific timing (performed on an intermediate material having a specific wire diameter) during wiredrawing. Thus, the degree of working in the working step is adjusted to control the strength and the elongation of the resultant wiredrawn material so that the strength and the elongation have respective desired values. Moreover, as the intermediate softening treatment is performed at a specific timing as described above, the effect of improving the strength based on work hardening by wiredrawing before the intermediate softening treatment is sufficiently achieved, and the elongation can be improved without excessively deteriorating the effect of improving the strength based on this work hardening. Moreover, it is considered that wiredrawing after the intermediate softening treatment can produce the effect of improving the strength based on work hardening, without excessively deteriorating the elongation enhanced by the intermediate softening treatment (preferably keeping an elongation at breakage of 5% or more of the wiredrawn material having its final wire diameter).

Further, according to the method of manufacturing a copper alloy wire of the embodiment, (i) the content of Mg and the content of P are each set to fall in a specific range, (ii) the precipitation as described above is used to control the amount of dissolved Mg and the amount dissolved P in the solid solution, and (iii) the intermediate softening treatment can be used to remove working strain. It is considered that the copper alloy wire can thus have a high electrical conductivity.

In addition, regarding the method of manufacturing a copper alloy wire of the embodiment, fine precipitates containing Mg and P are precipitated. Thus, effects such as the effect of improving the workability in plastic working (typically wiredrawing) which is performed later can be expected. Consequently, the copper alloy wire can be manufactured with high productivity.

According to the method of manufacturing a copper alloy wire of the embodiment, a copper alloy wire which has a high strength and is also excellent in elongation as described above, namely a semi-hard material having a stable structure, can be manufactured. In this respect, this manufacturing method is completely different from the method of manufacturing a copper alloy wire of Japanese Patent Laying-Open No. 2008-016284 (PTD 1) and Japanese Patent Laying-Open No. 58-197242 (PTD 2) disclosing a hard material (only wiredrawn, so-called H-material), and a soft material (so-called O-material) produced by completely annealing a hard material so that the material has a stable recrystallized structure. Here, as disclosed in Japanese Patent Laying-Open No. 58-197242 (PTD 2), a higher P content of 0.02% by mass or more causes a compound containing Mg and P to be easily precipitated, and thus a considerably bulky precipitate of 2 μm or more is formed. The presence of such a bulky precipitate causes deterioration of the fatigue resistance and the impact resistance. In view of this, the inventors of the present invention have studied manufacturing conditions for preventing such a bulky precipitate from being formed, while keeping a P content of not less than 0.02% by mass. Consequently, the inventors have found it preferable to first prepare a solid solution, then sufficiently form precipitates, and thereafter perform wiredrawing, and also perform intermediate softening treatment at an appropriate timing, as described above. Based on these findings, the method of manufacturing a copper alloy wire of the embodiment is defined as described above.

(14) As an example of the method of manufacturing a copper alloy wire of the embodiment, the method may be of the form in which the solid solution material is produced by casting a copper alloy having the composition and performing a solution heat treatment on the cast material.

This form includes the separate step of performing a heat treatment (solution heat treatment) for obtaining a solid solution material. Therefore, the solid solution conditions can be adjusted easily, the solid solution in which Mg and P are sufficiently dissolved can be easily obtained, and cast materials with f various shapes and any of various sizes can be used. Therefore, the casting conditions have a high degree of freedom. In particular, continuous casting produces effects such as the effects that mass production of a long cast material is possible, Mg and P can be dissolved to a certain extent in the solid solution since rapid cooling can be done in the cooling process, the crystal can be made finer through the rapid cooling in the cooling process, and the material excellent in workability can be obtained.

(15) As an example of the method of manufacturing a copper alloy wire of the embodiment, the method may be of the form in which the aged material is produced by performing an aging treatment on the solid solution material.

This form includes the separate step of performing a heat treatment (aging treatment) for obtaining the aged material. Therefore, the aging conditions can be adjusted easily, and the aged material in which considerably fine precipitates are uniformly dispersed can easily be manufactured.

(16) As an example of the method of manufacturing a copper alloy wire of the embodiment, the method may be of the form in which the method further includes an annealing step of further performing annealing on the wiredrawn material to cause the annealed wiredrawn material to have an elongation at breakage of not less than 5%.

This form includes the separate step of performing a heat treatment (annealing) on the wiredrawn material having its final wire diameter. Therefore, the elongation at breakage of the wire having the final wire diameter can reliably be adjusted to be a desired elongation (not less than 5%). Consequently, in this form, a copper alloy wire with a high strength and a high toughness having an electrical conductivity of not less than 60% IACS, a tensile strength of not less than 400 MPa, and an elongation at breakage of 5% can be manufactured.

### Details of Embodiments of the Invention

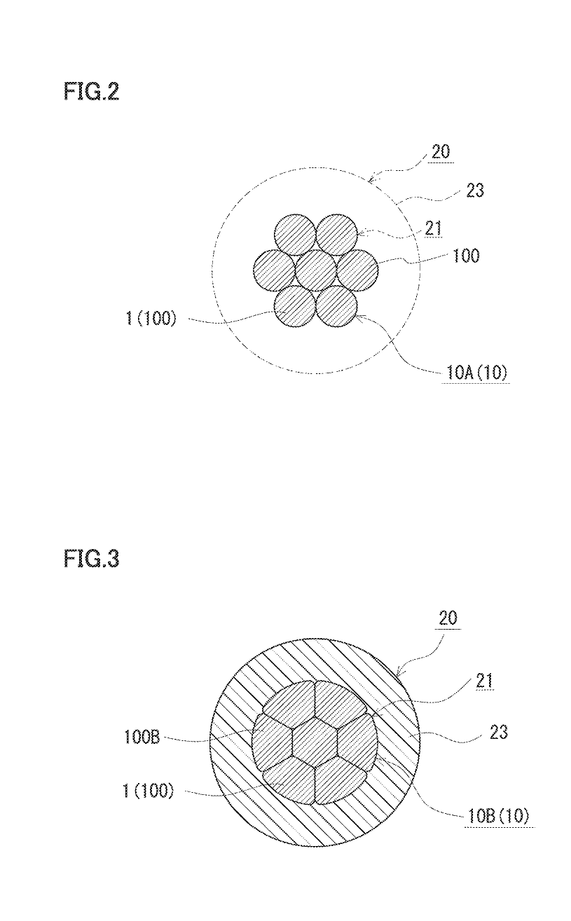

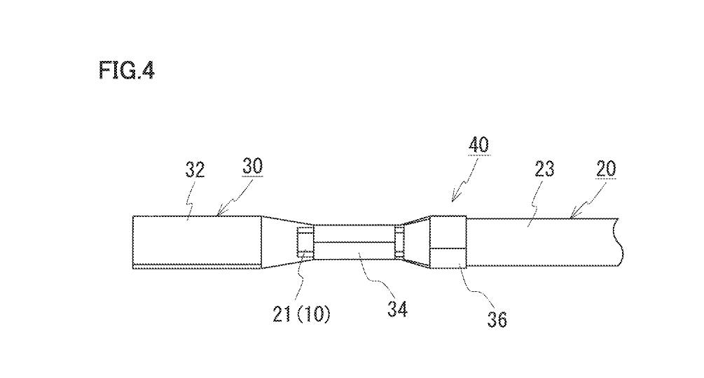

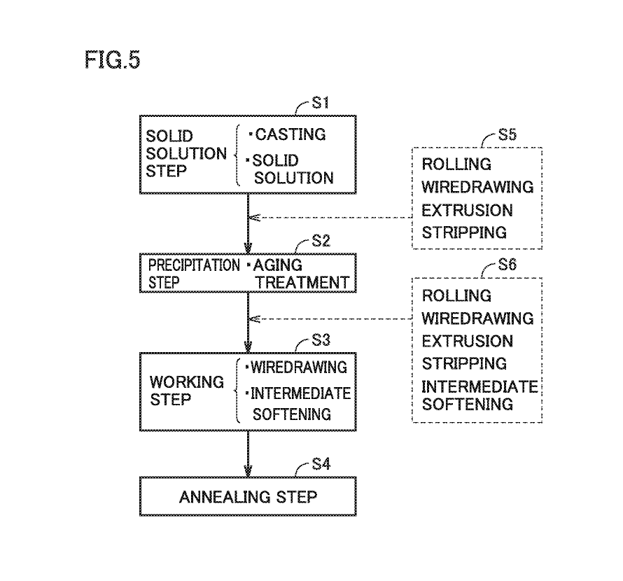

In the following, a copper alloy wire, a copper alloy stranded wire, an electric wire, a terminal-fitted electric wire, and a method of manufacturing a copper alloy wire according to the embodiments will be described in order. In the description of the copper alloy stranded wire and the electric wire, FIGS. 2 and 3 are referenced as appropriate. In the description of the terminal-fitted electric wire, FIG. 4 is referenced as appropriate. In the following description, components of the copper alloy are all expressed in % by mass. It is intended that the present invention is not limited to them as illustrated but defined by claims, and includes all modifications equivalent in meaning and scope to the claims. For example, modifications may be made as appropriate to the composition, the wire diameter, and the manufacturing conditions (such as the timing to perform the intermediate softening treatment, the temperature of each heat treatment, the holding time) of the copper alloy wire as indicated in connection with Test Examples described later herein.

[Copper Alloy Wire]

<Composition>

A copper alloy forming a copper alloy wire of the embodiment has a composition in which Mg and P are indispensable elements and the balance is Cu and inevitable impurities. The composition may further include, in addition to Mg and P, a specific range of at least one element selected from Fe, Sn, Ag, In, Sr, Zn, Ni, and Al.

Mg Content: not less than 0.2% by mass and not more than 1% by mass

A part of Mg is dissolved in Cu to form a solid solution and thereby solid-solution strengthen the copper alloy. An aging treatment or heating corresponding to the aging treatment is performed to form precipitates of the balance of Mg, and thereby improve the strength through the precipitation strengthening. An Mg content of not less than 0.2% by mass enables the strength enhancement effect to be produced satisfactorily, through solid solution strengthening and precipitation strengthening. Thus, a high strength copper alloy wire can be obtained. Moreover, precipitates are extremely fine and dispersed uniformly, which produces the effect of improving the strength through dispersion strengthening (precipitation strengthening). In addition, cracks and breakage are less likely to occur since the precipitates are extremely fine. Thus, the copper alloy wire which is further excellent in strength and also excellent in elongation can be obtained. A higher Mg content makes it easy to produce the effect of improving the strength through solid solution strengthening and precipitation strengthening. The Mg content may be not less than 0.3% by mass, and further may be not less than 0.4% by mass. Since the Mg content is not more than 1% by mass, the following effects are produced: (i) an appropriate amount of dissolved elements in the solid solution and an appropriate amount of precipitates can be generated, and a copper alloy wire can be manufactured with high productivity while suppressing deterioration of the strength, deterioration of elongation, deterioration of the workability, and the like, caused by excessive precipitation and/or a bulky precipitate, and (ii) deterioration of the electrical conductivity caused by excessive solid solution can be suppressed, and a copper alloy wire with a high electrical conductivity can be achieved. A lower Mg content facilitates suppression of the disadvantage due to a bulky precipitate and the disadvantage due to excessive solid solution. The Mg content may therefore be not more than 0.95% by mass and further may be not more than 0.9% by mass. The Mg content adjusted in this way makes it easy to obtain a copper alloy wire which is excellent in electrical conductivity, strength, and toughness.

P Content: not less than 0.02% by mass and not more than 0.1% by mass

P contributes to precipitation of Mg. An aging treatment or heating corresponding to the aging treatment is performed to form P precipitates together with Mg precipitates, and accordingly the strength is improved through the precipitation strengthening. A P content of not less than 0.02% by mass can promote precipitation of Mg. Thus, the effect of improving the strength through precipitation strengthening is produced satisfactorily. A high-strength copper alloy can accordingly be obtained. A higher P content makes it easier to precipitate Mg. The P content may be more than 0.02% by mass, and further, not less than 0.03% by mass. The copper alloy wire of the embodiment includes a high P content of not less than 0.02% by mass. In addition, manufacturing conditions are controlled so that precipitates are extremely small while precipitation of Mg is promoted. Accordingly, both a high strength, specifically a tensile strength of not less than 400 MPa, and a high toughness, specifically an elongation at breakage of not less than 5%, can be achieved. A P content of not more than 0.1% by mass suppresses excessive precipitation of Mg. Thus, the effect of improving the strength can be obtained appropriately through solid solution strengthening of Mg and precipitation strengthening by precipitates of a compound containing Mg and P, for example. A lower P content facilitates suppression of excessive precipitation of Mg and thus a bulky precipitate can be prevented from being formed. In view of this, the P content may be not more than 0.095% by mass, and further may be not more than 0.09% by mass. The P content can be adjusted in this way to make it easier to obtain a copper alloy wire which is excellent in electrical conductivity, strength, and toughness.
Mg/P=not less than 4 and not more than 30

The Mg content is adjusted with respect to the P content. This is preferable because excessive precipitation of Mg can be suppressed while precipitation of Mg is promoted by P, and accordingly, the effect of improving the strength is satisfactorily obtained through solid solution strengthening by Mg and precipitation strengthening by precipitates such as a compound containing Mg and P. Specifically, when a mass ratio: Mg/P of 4 or more is met, Mg can be precipitated satisfactorily. When Mg/P of 30 or less is met, excessive precipitation of Mg can be suppressed. Mg/P of 6 or more and Mg/P of 8 or more are preferred, since the electrical conductivity, the strength, and the elongation are well-balanced. A smaller Mg/P means that the Mg content is relatively lower, which causes a smaller amount of solid solution and a higher electrical conductivity. In view of this, Mg/P is preferably 25 or less, and more preferably 20 or less, for the sake of electrical conductivity.

Additional Elements

The composition which includes, in addition to the specified content of Mg and the specified content of P, not less than 0.01% by mass in total of at least one element selected from Fe, Sn, Ag, In, Sr, Zn, Ni, and Al makes it easy to increase the strength, and a higher total content of the element(s) makes it easier to increase the strength. The composition including not more than 0.5% by mass in total of these elements makes it less likely that the electrical conductivity is deteriorated, and can provide a high electrical conductivity. These elements are dissolved in the matrix or present in the form of precipitates (may be included in the precipitates containing Mg and P). The aforementioned total content of the element(s) may be not less than 0.02% by mass and not more than 0.4% by mass, and further may be not less than 0.03% by mass and not more than 0.3% by mass.

<Structure>

A copper alloy forming a copper alloy wire of the embodiment has a structure in which a precipitate, which is typically a compound containing Mg and P, is dispersed in a matrix. Preferably, the copper alloy has a structure in which the precipitate is extremely fine and uniformly dispersed. For example, the compound may have an average particle size of 500 nm or less. The fact that the precipitate is such a fine particle produces the effect of improving the strength through dispersion strengthening. Moreover, since a bulky precipitate (a micro-order particle of 2 μm or more for example) which may become an origin of a crack is substantially absent, the effect of improving the strength, the effect of improving the toughness (particularly flexural property and impact resistance), and the effect of improving the workability, for example, are obtained. Since a smaller average particle size of the precipitate enables improvement of the strength and improvement of the toughness through dispersion strengthening and the like, the average particle size is preferably 400 nm or less, more preferably 350 nm or less. In addition to the average particle size, the maximum particle size is also preferably small. Specifically, the maximum particle size of the precipitate is preferably 800 nm or less, more preferably 500 nm or less, and still more preferably 400 nm or less. The size of the precipitate can be adjusted to the aforementioned specific size, by appropriately controlling the manufacturing conditions, as will be described later herein. A description will be given later herein of how to measure the average particle size and the maximum particle size of the precipitate. Regarding the copper alloy wire manufactured in accordance with the manufacturing method described later herein, the size of the precipitate of the aged material can substantially be maintained, even when the intermediate softening treatment is performed during wiredrawing, or annealing is performed on the wiredrawn material having its final wire diameter. Namely, in the copper alloy wire of the embodiment, typically the size of the precipitate in the wiredrawn material with its final wire diameter is substantially equal to the size of the precipitate in the aged material.

The average particle size of the matrix including Cu is preferably not more than 10 μm, since such a size allows the copper alloy wire to have an excellent elongation and further enables the terminal-fixing strength of the copper alloy wire to be increased. Here, the average particle size of the matrix is a value measured in the following way. First, a cross section is subjected to a treatment by a cross section polisher (CP), and this cross section is observed with a scanning electron microscope (SEM). The area of any observed range is divided by the number of particles present in this range. The diameter of a circle corresponding to the area, which is the quotient of the above division, is the average crystal particle size. It should be noted that the observed range is a range in which 50 or more particles are present, or the whole cross section.

<Shape>

The copper alloy wire of the embodiment is typically a round wire having a circular cross section (see copper alloy wire 1 shown in FIG. 2). Besides, the copper alloy wire may be a deformed wire having a rectangular cross section, a polygonal cross section, an elliptical cross section, or the like, which is obtained by appropriately changing the shape of a die used for wiredrawing.

<Size>

The copper alloy wire of the embodiment may have any of a variety of wire diameters and any of a variety of cross-sectional areas. In particular, for an application such as a conductor of an electric wire for an automobile where a small diameter is desired for the sake of reducing the weight, the wire diameter is preferably not more than 0.35 mm, more preferably not more than 0.3 mm, since the cross-sectional area can be reduced even when wires are stranded into a stranded wire. The copper alloy wire may have a still smaller diameter, namely a wire diameter of not more than 0.25 mm. Further, in this application, the wire having a wire diameter of more than 0.1 mm is easy to strand for example and thus easy to use.

<Properties>

The copper alloy wire of the embodiment is excellent in electrical conductivity and has a high strength and a high toughness, as described above. Specifically, the copper alloy wire has an electrical conductivity of not less than 60% IACS, a tensile strength of not less than 400 MPa, and an elongation at breakage of not less than 5% (they are all at room temperature). The composition and the manufacturing conditions can be adjusted to obtain a copper alloy wire satisfying an electrical conductivity of not less than 62% IACS, a tensile strength of not less than 410 MPa, and an elongation at breakage of not less than 6%, and further obtain a copper alloy wire satisfying an electrical conductivity of not less than 65% IACS, a tensile strength of not less than 420 MPa, and an elongation at breakage of not less than 7%. Further, a copper alloy wire satisfying a tensile strength of not less than 450 MPa can be obtained.

[Copper Alloy Stranded Wire]

A copper alloy stranded wire 10 of an embodiment is made up of a plurality of constituent wires 100 stranded together. Among these constituent wires, at least one wire is a copper alloy wire 1 of the above-described embodiment. The copper alloy stranded wire may take any of the form in which a plurality of constituent wires 100 are all copper alloy wires 1 of the embodiment, and a form in which only a part of a plurality of constituent wires 100 is copper alloy wires 1 of the embodiment (not shown). The number of constituent wires is not particularly limited, but the typical number of constituent wires is 7, 11, and 19 (FIGS. 2 and 3 each show a case of 7 wires by way of example).

In the form (the form shown in FIGS. 2 and 3) in which all of a plurality of constituent wires 100 are copper alloy wires 1 of the embodiment, all constituent wires 100 are of the same material. Therefore, stranding is easy to do and high productivity of copper alloy stranded wire 10 is achieved. In this form, constituent wires 100 are substantially identical in composition and structure, and the composition and the structure of copper alloy wires 1 of the embodiment before stranded are substantially maintained. Therefore, the electrical conductivity, the tensile strength, and the elongation at breakage of each constituent wire 100 are substantially kept identical to the electrical conductivity, the tensile strength, and the elongation at breakage of copper alloy wire 1 before stranded. Thus, copper alloy stranded wire 10 in this form can have an excellent electrical conductivity, a high strength, and a high toughness. Specifically, copper alloy stranded wire 10 satisfying an electrical conductivity of not less than 60% IACS, a tensile strength of not less than 400 MPa, and an elongation at breakage of not less than 5% can be obtained.

In a form in which a plurality of constituent wires 100 include, in addition to copper alloy wire 1 of the embodiment, a wire of a different material (not shown), effects derived from this different material can be expected. For example, from a form in which a part of constituent wires 100 includes a pure copper wire, improvement of the electrical conductivity and improvement of the toughness can be expected. For example, from a form in which a part of constituent wires 100 includes a wire of an iron-based material such as stainless steel, improvement of the strength can be expected. For example, from a form in which a part of constituent wires 100 includes a light metal wire of pure aluminum or aluminum alloy, reduction of the weight can be expected.

The form of copper alloy stranded wire 10 of the embodiment may be a form in which a plurality of constituent wires 100 are only stranded together (copper alloy stranded wire 10A shown in FIG. 2), or a form in which a plurality of constituent wires 100 are stranded together and thereafter compression-molded (copper alloy stranded wire 10B shown in FIG. 3, i.e., compressed wire). In the case of compressed wire 10B, the envelope circle enclosing the stranded constituent wires can be made smaller relative to that of constituent wires only stranded together. Namely, the wire diameter and the cross-sectional area of the stranded wire can further be reduced, and the stranded wire can suitably be used for a conductor of an electric wire for an automobile, for example. Compressed wire 10B is typically in the form having a circular cross section as shown in FIG. 3. The composition and structure of each constituent wire 100B forming compressed wire 10B are substantially kept identical to the composition and structure of constituent wire 100 before stranded. Therefore, the electrical conductivity, the tensile strength, and the elongation at breakage of wire 100B are substantially kept identical to the electrical conductivity, the tensile strength, and the elongation at breakage of wire 100 (copper alloy wire 1 in this case) before stranded. For example, in the case where all of constituent wires 100B are copper alloy wires 1 of the embodiment, compressed wire 10B satisfying an electrical conductivity of not less than 60% IACS, a tensile strength of not less than 400 MPa, and an elongation at breakage of not less than 5% can be obtained. In the case of the compressed wire, work hardening by compression molding may slightly improve the strength as compared with that before compression molding.

Copper alloy stranded wire 10 of the embodiment may have any of various sizes. In particular, copper stranded alloy wire 10 having a cross-sectional area of not less than 0.05 mm² and not more than 0.5 mm² can suitably be used for an application such as a conductor of an electric wire for an automobile. In this application, copper alloy stranded wire 10 having a cross-sectional area of not less than 0.07 mm² and not more than 0.3 mm² is easier to use. The wire diameter and the cross-sectional area of constituent wire 100, the number of constituent wires, and the degree of compression in the case of the compressed wire, for example, may be adjusted so that the cross-sectional area of the copper alloy stranded wire falls in the aforementioned range. The twist pitch of the copper alloy wires can be set to 10 mm or more to improve the productivity of the copper alloy stranded wire. In contrast, the twist pitch of the copper alloy wires can be set to 20 mm or less to improve the flexibility of the copper alloy stranded wire.

[Electric Wire]

An electric wire 20 of an embodiment includes a conductor 21 and an insulating layer 23 covering the surface of conductor 21. Conductor 21 is copper alloy wire 1 of the above-described embodiment, copper alloy stranded wire 10A (FIG. 2) of the embodiment, or compressed wire 10B (FIG. 3) of the embodiment. The composition and the structure, the electrical conductivity, the tensile strength, and the elongation at breakage of copper alloy wire 1 or copper alloy stranded wire 10 forming conductor 21 are substantially kept identical to those of copper alloy wire 1 or copper alloy stranded wire 10 before insulating layer 23 is formed. Therefore, typically electric wire 20 including conductor 21 satisfying an electrical conductivity of not less than 60% IACS, a tensile strength of not less than 400 MPa, and an elongation at breakage of not less than 5% can be obtained.

As the material and formation of insulating layer 23, a known material and a known manufacturing method can be used. For example, the material for insulating layer 23 may be polyvinyl chloride (PVC), non-halogen resin, an insulating material having excellent fire resistance, or the like. The material and the thickness of insulating layer 23 can appropriately be selected in consideration of a desired electrical insulation strength, and are not particularly limited. The thickness of insulating layer 23 shown in FIGS. 2 and 3 is given by way of example.

[Terminal-Fitted Electric Wire]

A terminal-fitted electric wire 40 of an embodiment includes electric wire 20 of the embodiment, and a terminal portion 30 attached to an end of electric wire 20. Specifically, insulating layer 23 at the end of electric wire 20 is stripped away to expose the end of conductor 21, and terminal portion 30 is connected to the exposed portion. Terminal portion 30 made of a known material and having a known shape may be used. For example, the terminal portion may be a press-fit-type terminal (male or female type) made of a copper alloy such as brass. FIG. 4 exemplarily shows a female-type press-fit terminal including a box-shaped fit portion 32, a wire barrel portion 34 in which conductor 21 is press fit, and an insulation barrel portion 36 in which insulating layer 23 is press fit. Terminal-fitted electric wire 40 of the embodiment includes, as conductor 21, copper alloy wire 1 or copper alloy stranded wire 10 of the embodiment that has a high strength and is also excellent in toughness. Therefore, after the press-fit-type terminal portion is attached, the stress generated during press-fitting is less likely to be alleviated and the state of connection between conductor 21 and the terminal portion can satisfactorily be maintained over a long time. Consequently, use of terminal-fitted electric wire 40 of the embodiment enables electrical connection between devices through electric wire 21 and terminal portion 30 to be maintained satisfactorily over a long time. In addition, the terminal portion may be joined to conductor 21 by means of solder or the like. Moreover, an electric wire group in which a plurality of electric wires 20 share one terminal portion may be provided. In this case, a plurality of electric wires 20 are bundled together by means of a bundling tool or the like, and accordingly excellent handling of the group of electric wires is achieved.

[Method of Manufacturing Copper Alloy Wire]

A copper alloy wire of the embodiment which has the above-described specific composition and has the specific structure in which a compound containing Mg and P is dispersed can be manufactured for example in accordance with a method of manufacturing a copper alloy wire of an embodiment including a solid solution step, a precipitation step, and a working step as described below. In the following, a detailed description will be given step by step.

<Solid Solution Step>

This step is the step of preparing a solid solution material (preferably a supersaturated solid solution) having a composition including Mg in the above-specified range and P in the above-specified range and having a structure in which these Mg and P are dissolved in Cu. Since the solid solution material is prepared, a precipitate such as a compound containing Mg and P can finely and uniformly be precipitated in the subsequent precipitation step. The solid solution material may be obtained for example through the following two methods (A), (B).

(A) A copper alloy having the above-described composition is cast and the resultant cast material is subjected to a solution heat treatment.

(B) A copper alloy having the above-described composition is subjected to continuous casting and rapidly cooled in a cooling process in this casting.

According to Method (A), the casting step and the step of performing the solution heat treatment are separate steps, and therefore, the conditions for the solution heat treatment are easy to adjust, Mg and P can more reliably be dissolved, and the cast material having any of various shapes can be used. For example, an ingot created by means of a mold having a predetermined shape can be used. In the casting step, continuous casting may be performed. This is preferred since a long cast material can easily be manufactured and the productivity of the cast material is excellent. Moreover, this is also preferred since such a long cast material can be used as a material for a wiredrawn material, and thus a high productivity of the wiredrawn material is also achieved. Further, the continuous casting can rapidly cool the molten alloy as compared with the case where the ingot is produced, and therefore, in addition to solid solution of Mg and P through rapid cooling, finer crystal can be expected. The finer crystal can improve plastic working such as wiredrawing. In view of this, use of the continuous casting is preferred since it provides a high productivity of the wiredrawn material. For the continuous casting, any of various methods such as the belt and wheel system, the twin belt system, the upcast system, and the like can be used. As a matter of course, any known continuous casting method may also be used.

The conditions for the solution heat treatment may include, in the case of batch processing, a holding temperature of not less than 750° C. and not more than 1000° C. and a holding time of not less than five minutes and not more than four hours, for example. Further, the holding temperature may be set to not less than 800° C. and not more than 950° C., and the holding time may be set to not less than 30 minutes and not more than three hours. In the case of continuous processing, the conditions may be adjusted so that a solid solution can be obtained. Depending on the composition or the like, correlation data between conditions for the continuous processing and the structure after the continuous processing may be prepared, so that appropriate conditions can easily be selected. The solution heat treatment can be performed after the continuous casting is performed. In this case, Mg and P can more reliably be dissolved. The ambient may for example be an inert ambient which can prevent oxidation.

According to Method (B), cooling conditions in the continuous casting can be adjusted to easily manufacture a long solid solution material, and therefore, Method (B) is excellent in productivity of the solid solution material. A specific condition for rapid cooling may be a solidification rate of 5° C./sec or more, and may further be a solidification rate of 10° C./sec or more. The solidification rate is determined by {(temperature of molten metal, ° C.)−(surface temperature of cast material immediately after casting, ° C.)}×(casting rate, m/sec)/(mold length, m). The size of the cast material (cross-sectional area), the temperature of the molten metal, the temperature of the mold, the casting rate (length of cast material/time), the size of the mold, and the like, may be adjusted so that the solidification rate falls in the above-described range. Typically, the mold temperature may be set low (80° C. or less for example).

<Precipitation Step>

This step is the step of promoting precipitation of a precipitate such as a compound containing Mg and P, from the above-described solid solution material, to thereby produce an aged material having a structure in which the precipitate is dispersed. The aged material is produced and the precipitate is generated from the above-described solid solution material, and accordingly, extremely fine precipitates are generated and these fine particles are uniformly dispersed, to thereby produce the effect of improving the strength through dispersion strengthening. Further, generation of the precipitate is promoted to thereby reduce the amount of the dissolved elements and improve the electrical conductivity. The aged material may be obtained for example through the following two methods (α), (β).

(α) The above-described solid solution material is subjected to an aging treatment (artificial aging) to produce the aged material.

(β) The above-described solid solution material is subjected to warm working or hot working to produce the aged material.

According to Method (α), conditions for the aging treatment are easy to adjust, and a precipitate such as a compound containing Mg and P can satisfactorily be precipitated. In the case of batch processing, the conditions for the aging treatment may for example be a holding temperature of not less than 300° C. and not more than 600° C., and a holding time of not less than 30 minutes and not more than 40 hours. Further, the holding temperature may be not less than 350° C. and not more than 550° C., and the holding time may be not less than one hour and not more than 20 hours. In the case of continuous processing, the conditions may be adjusted so that a desired structure (particularly a structure in which fine precipitates are present) can be obtained. Depending on the composition or the like, correlation data between conditions for the continuous processing and the structure after the continuous processing may be prepared, so that appropriate conditions can easily be selected. The ambient may for example be an inert ambient, which can prevent oxidation.

According to Method (β), heating for warm working or hot working is used not only for plastic working but also for the aging treatment, to accordingly perform the plastic working and the aging treatment simultaneously. Method (β) can be performed for example through a conform process. Such Method (β) can be expected to achieve not only precipitation through static heating but also dynamic precipitation through plastic working in a heated condition. The dynamic precipitation can be expected to enable still finer precipitates and uniform dispersion of the precipitates. The plastic working may specifically be rolling, extrusion, forging, and the like. The working conditions (degree of working, strain rate, heating state (heating temperature for a mold, heating temperature for a material, working heat, and the like)) may be adjusted, so that a heating state necessary for precipitation of the precipitate can be maintained. According to Method (β), warm or hot plastic working is performed before wiredrawing, to thereby enable reduction or removal of casting defects, and accordingly the workability of wiredrawing can be enhanced.

<Working Step>

This step is the step of performing wiredrawing on the above-described aged material until it has a final wire diameter, to thereby produce a wiredrawn material. According to the method of manufacturing a copper alloy wire of the embodiment, wiredrawing in the working step is performed in a plurality of passes, and an intermediate softening treatment is performed in an intermediate pass. The intermediate softening treatment is performed to remove working strain to thereby enhance the workability of wiredrawing in subsequent passes, enhance the electrical conductivity, and also enhance the elongation. In particular, according to the method of manufacturing a copper alloy wire of the embodiment, the intermediate softening treatment is performed on an intermediate material having a specific size. In this way, even when wiredrawing is performed in passes subsequent to the intermediate softening treatment, the high elongation and the high electrical conductivity are maintained, and the strength which is deteriorated due to annealing can be increased again by work hardening. Consequently, the wiredrawn material having the final wire diameter can have an electrical conductivity of not less than 60% IACS and a tensile stress of not less than 400 MPa and preferably have an elongation at breakage of not less than 5%. The method of manufacturing a copper alloy wire of the embodiment can be used to manufacture such a semi-hard copper alloy wire.

The wiredrawing is cold working. For the wiredrawing, a wiredrawing die or the like may be used. The number of passes can appropriately be selected. The degree of wiredrawing per pass may appropriately be adjusted so that the predetermined final wire diameter is reached and the number of passes may accordingly be set.

For the intermediate softening treatment, the conditions are adjusted so that the elongation at breakage of the intermediate material after the intermediate softening treatment is not less than 5%, for example. Specifically, in the case of batch processing, the holding temperature is not less than 250° C. and not more than 500° C. and the holding time is not less than 10 minutes and not more than 40 hours. Further, the holding temperature may be set to not less than 300° C. and not more than 450° C. and the holding time may be set to not less than 30 minutes and not more than 10 hours. The holding temperature may be set relatively low and the holding time may be set relatively short for the intermediate softening treatment. For example, they may be set equal to or less than the holding temperature and the holding time in the precipitation step (typically the holding temperature and the holding time in the aging treatment based on batch processing). In this case, growth of precipitates in the intermediate softening treatment step is hindered, and the fine precipitates formed in the precipitation step are easy to maintain even after the intermediate softening treatment. In the case of continuous processing, the conditions may be adjusted so that desired properties (for example, an elongation at breakage after the intermediate softening treatment of not less than 5%) are obtained. Depending on the composition, the wire diameter, or the like, correlation data between conditions for the continuous processing and properties after the continuous processing may be prepared, so that appropriate conditions can easily be selected. The ambient may for example be an inert ambient which can prevent oxidation.

The intermediate softening treatment is performed on an intermediate material having an intermediate wire diameter of more than one time and not more than ten times as large as the final wire diameter. The intermediate softening treatment is performed on such an intermediate material to enable the total degree of working (reduction ratio of the total cross section) in the intermediate softening treatment and subsequent steps to be 99% or less. While the strength is decreased by the intermediate softening treatment, work hardening by wiredrawing after the intermediate softening treatment enables sufficient increase of the strength. Consequently, the wiredrawn material after final wiredrawing can have a tensile strength of 400 MPa or more. If the intermediate softening treatment is performed on a wire having a diameter of more than ten times as large as the final wire diameter, namely a wire having a diameter considerably larger than the final wire diameter, the total degree of working thereafter is excessively large. Thus, regarding the finally obtained wiredrawn material (hard material), the effect of improving the strength through work hardening is excessively large while the elongation is low. If the softening treatment is performed on a wire having a diameter which is one time as large as the final wire diameter, namely a wire having the final wire diameter, the effect of improving the strength through work hardening after this softening treatment is not obtained. Thus, the finally obtained wiredrawn material has a low strength, specifically a tensile strength of less than 400 MPa. Preferably the intermediate softening treatment is performed on an intermediate material having a diameter of not less than 1.5 times and not more than 8 times as large as the final wire diameter.

According to disclosure of intermediate heat treatment in Example 1 of Japanese Patent Laying-Open No. 58-197242 (PTD 2), in the case where a small-diameter wire is produced through wiredrawing in a plurality of passes, softening treatment is performed in an intermediate pass. However, this softening treatment is performed when the intermediate wire diameter is still significantly large (more than ten times as large as the final wire diameter for example), and the degree of working after the intermediate heat treatment is large. In other words, it is difficult or substantially impossible to increase the toughness such as elongation. In this respect, the method of manufacturing a copper alloy wire of the embodiment is completely different from the conventional method of manufacturing a copper alloy wire.

<Annealing Step>

On the wiredrawn material having the final wire diameter, annealing may separately be performed. This annealing enables the annealed wire to have an elongation at breakage of not less than 5%, or still more. Here, according to the method of manufacturing a copper alloy wire of the embodiment, the intermediate softening treatment is performed at an appropriate timing, so that the wiredrawn material which is excellent in elongation even after final wiredrawing can be obtained. However, the annealing step is separately provided to facilitate adjustment of the annealing conditions and improvement of the elongation at breakage. Moreover, this annealing can remove working strain resultant from wiredrawing in and after the intermediate softening treatment. Thus, improvement of the electrical conductivity (for example, an improvement on the order of 3% IACS to 5% IACS relative to the case where this annealing is not performed) can also be achieved.

As the annealing conditions, the conditions described above in connection with the intermediate softening treatment can be used. Depending on elongation of the wiredrawn material on which annealing is to be performed, the holding temperature may be set lower or higher than the holding temperature for the intermediate softening treatment, or the holding time may be set shorter or longer than the holding time for the intermediate softening treatment. Moreover, for the annealing, the holding temperature and the holding time are adjusted so that a tensile strength of not less than 400 MPa is achieved.

<Other Steps>

According to the method of manufacturing a copper alloy wire of the embodiment, as shown in FIG. 5, the solid solution step (S1), the precipitation step (S2), the working step (S3), and the annealing step (S4) are performed in this order. Here, in the solid solution step (S1), a copper alloy is cast and the resultant cast material is subjected to the solution heat treatment and accordingly a solid solution material is prepared. In the precipitation step (S2), the solid solution material is subjected to the aging treatment, and accordingly an aged material is obtained. In the working step (S3), the aged material is subjected to the wiredrawing and the intermediate softening treatment.

In the present embodiment, the solid solution material may be subjected to a process (S5) such as rolling, wiredrawing, extrusion, stripping, and the like, between the solid solution step (S1) and the precipitation step (S2). As to the process such as rolling, wiredrawing, extrusion, stripping, and the like, one of these processes may be performed or a combination of multiple processes may be performed. Further, each process may be performed once or multiple times.

In the present embodiment, between the precipitation step (S2) and the working step (S3), a process (S6) such as rolling, wiredrawing, extrusion, stripping, intermediate softening, and the like may be performed on the aged material. As to the process such as rolling, wiredrawing, extrusion, stripping, intermediate softening, and the like, one of these processes may be performed or a combination of multiple processes may be performed. Further, each process may be performed once or multiple times.

[Method of Manufacturing Copper Alloy Stranded Wire]

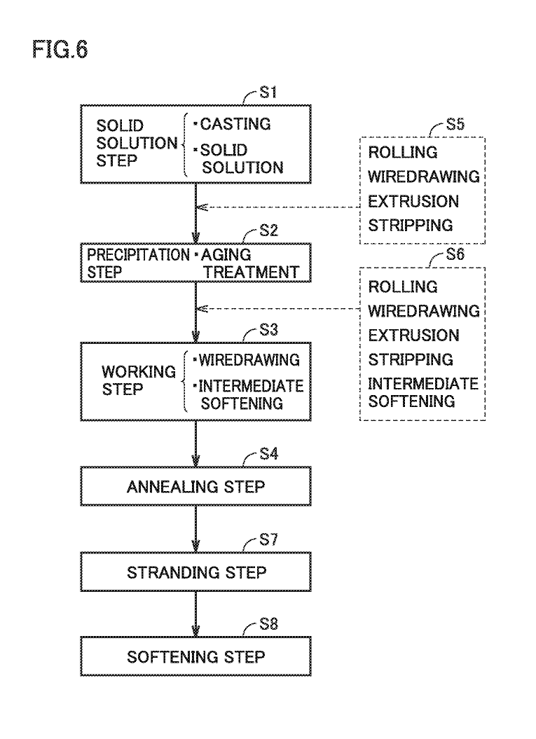

According to a method of manufacturing a copper alloy stranded wire of an embodiment, as shown in FIG. 6, the solid solution step (S1), the precipitation step (S2), the working step (S3), the annealing step (S4), the stranding step (S7), and the softening step (S8) are performed in this order.

The solid solution step (S1), the precipitation step (S2), the working step (S3), and the annealing step (S4) of the present embodiment can be performed in a similar way to the method of manufacturing a copper alloy wire. Further, like the method of manufacturing a copper alloy wire, a process (S5) such as rolling, wiredrawing, extrusion, stripping, and the like may be performed on the solid solution material, between the solid solution step (S1) and the precipitation step (S2). Moreover, between the precipitation step (S2) and the working step (S3), a process (S6) such as rolling, wiredrawing, extrusion, stripping, intermediate softening, and the like may be performed on the aged material.

Subsequent to the annealing step, a plurality of copper alloy wires obtained through the annealing step are stranded together into a stranded wire (S7). After this, the stranded wire is subjected to a softening treatment to produce a copper alloy wire. In the case of batch processing, the softening treatment is performed under the conditions that the holding temperature is not less than 200° C. and not more than 500° C. and the holding time is not less than 10 minutes and not more than 40 hours. Further, the holding temperature may be not less than 250° C. and not more than 450° C. and the holding time may be not less than 30 minutes. Instead, continuous processing may be performed.

In the following, the properties, the structure, the manufacturing conditions, and the like of the copper alloy wire will specifically be described based on Test Examples.

### Test Example 1

A copper alloy wire was produced through the process: continuous casting→solid solution→aging∝wiredrawing (during which intermediate softening treatment is performed)→annealing, and the properties (tensile strength, elongation at breakage, electrical conductivity) and the structure of the obtained copper alloy wire were examined.

As raw materials, electrolytic copper having a purity of 99.99% or more and additive elements shown in Table 1 were prepared, placed in a high-purity carbon crucible and vacuum-melted. Thus, a molten alloy having the composition shown in Table 1 was produced. A continuous casting apparatus provided with a high-purity carbon mold is used to perform continuous casting on the obtained molten alloy. Thus, a cast material having a circular cross section (wire diameter φ 16 mm) was produced. On the obtained cast material, swaging was performed. Thus, a rod material with a wire diameter of φ 12 mm was obtained. While swaging was performed here, continuous casting can be performed to produce a cast material with a wire diameter of φ 12 mm. On the obtained rod material with a wire diameter of φ 12 mm, a solution heat treatment was performed under the condition of 900° C.×one hour. Thus, a solid solution material was produced. Subsequently, an aging treatment was performed on the solid solution material under the condition of 450° C.×8 hours. Thus, an aged material was produced. On the aged material on which the solution heat treatment and the aging treatment had been performed, wiredrawing was performed in a plurality of passes. Thus, a wiredrawn material was produced. Here, on an intermediate material with a wire diameter of φ 0.4 mm obtained through wiredrawing, an intermediate softening treatment was performed under the condition of 450° C.×one hour. This intermediate material had an intermediate wire diameter of twice as large as the final wire diameter. After the intermediate softening treatment, wiredrawing was performed until a wire diameter of φ 0.2 mm was reached. Thus, the wiredrawn material having the final wire diameter of φ 0.2 mm was produced. On the obtained wiredrawn material, an annealing treatment was performed under the condition of not less than 300° C. and not more than 450° C.×one hour. Accordingly, a copper alloy wire was obtained.

Regarding the obtained copper alloy wire, the tensile strength (MPa), the elongation at breakage (%), and the electrical conductivity (% IACS) at room temperature were examined. The results are shown in Table 1.

The tensile strength and the elongation at breakage were measured with a commercially available tensile tester in accordance with JIS Z 2241 (2011) (gauge length GL=250 mm). The electrical conductivity was measured based on the four-terminal method. Here, three specimens were prepared per sample. The aforementioned properties of each specimen were measured. The average value of each property calculated from the three specimens is shown in Table 1.

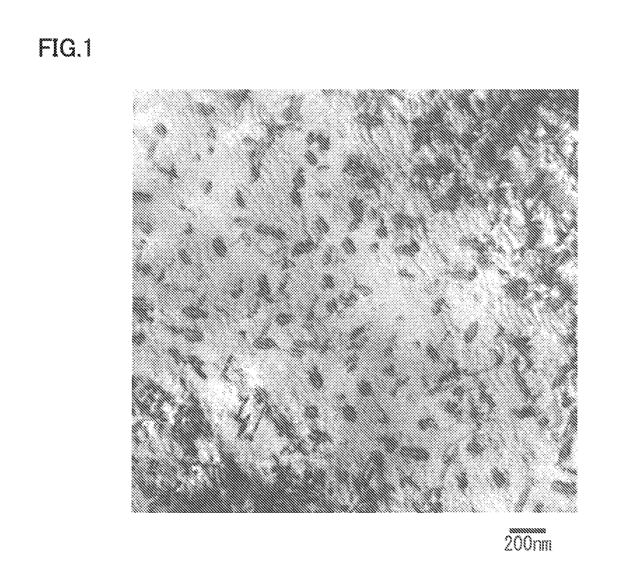

Internal observation of the aged materials of Sample No. 1 to Sample No. 3 was done with a transmission electron microscope (TEM). FIG. 1 is a photomicrograph of a cross section of the aged material of Sample No. 1-3.

TABLE 1

| | | | | | | properties | | |
|---|---|---|---|---|---|---|---|---|
| | | | | | | | elongation | |
| | | | | | | tensile | at | electrical |
| Sample | composition (% by mass) | | | | | strength | breakage | conductivity |
| No. | Cu | Mg | P | others | Mg/P | (MPa) | (%) | (% IACS) |
| 1-1 | Bal. | 0.84 | 0.061 | — | 13.77 | 444 | 7 | 62 |
| 1-2 | Bal. | 0.53 | 0.050 | — | 10.60 | 520 | 11 | 70 |
| 1-3 | Bal. | 0.44 | 0.047 | — | 9.36 | 470 | 8 | 74 |
| 1-4 | Bal. | 0.50 | 0.040 | Sn: 0.1 | 12.50 | 510 | 10 | 68 |
| 1-5 | Bal. | 0.51 | 0.041 | Ag: 0.02 | 12.44 | 505 | 10 | 69 |
| | | | | Sr: 0.01 | | | | |
| | | | | Ni: 0.01 | | | | |
| 1-6 | Bal. | 0.48 | 0.050 | In: 0.02 | 9.60 | 490 | 11 | 72 |
| | | | | Zn: 0.01 | | | | |
| | | | | Al: 0.01 | | | | |
| 1-7 | Bal. | 0.30 | 0.072 | Fe: 0.08 | 4.17 | 525 | 10 | 68 |
| 1-8 | Bal. | 0.79 | 0.023 | — | 34.3 | 415 | 7 | 62 |
| 1-9 | Bal. | 0.30 | 0.095 | — | 3.16 | 470 | 8 | 80 |
| 1-101 | Bal. | 1.20 | 0.062 | — | 19.4 | 600 | 9 | 45 |
| 1-102 | Bal. | 0.12 | 0.23 | — | 0.52 | 370 | 10 | 90 |
| 1-103 | Bal. | 0.32 | 0.13 | — | 2.46 | 380 | 10 | 78 |
| 1-104 | Bal. | 0.95 | 0.20 | — | 4.75 | — | — | — |

As shown in Table 1, it is seen that Samples of No. 1-1 to No. 1-9 containing not less than 0.2% by mass and not more than 1% by mass of Mg and not less than 0.02% by mass and not more than 0.1% by mass of P are all excellent in electrical conductivity, high in strength, and also excellent in elongation. Specifically, Samples of No. 1-1 to No. 1-9 all have an electrical conductivity of not less than 60% IACS (here, not less than 62% IACS, and not less than 65% IACS for most samples), a tensile strength of not less than 400 MPa (here, not less than 415 MPa, and not less than 440 MPa for most samples), and an elongation at breakage of not less than 5% (here, not less than 7%, and not less than 10% for most samples). It is seen that the samples containing, in addition to Mg and P, at least one element (here, only one element or two or more elements) selected from Fe, Sn, Ag, In, Sr, Zn, Ni, and Al are still more superior in strength.

It is seen that the aged materials of the produced samples have a structure as shown in FIG. 1 in which extremely fine particles are uniformly dispersed in the matrix. According to a component analysis of these particles, the particles including Mg and P are present and they are considered as precipitates which were precipitated through the above-described aging treatment. For the above component analysis, a known system can be used. For example, an energy dispersive x-ray spectrometer or the like can be used. Further, it is seen that these particles are elliptical particles having a length of approximately not less than 50 nm and not more than 100 nm as shown in FIG. 1. In the observed image, the maximum length of each particle is defined here as a diameter. Then, the average particle size (the average of 30 or more particles here) is 200 nm or less, and the maximum diameter is also 200 nm or less. The maximum length can easily be measured through an image analysis of the observed image with a commercially available image processor. The aged materials of the samples other than Sample No. 1-3 also have a structure in which extremely fine particles (precipitates containing Mg and P) are uniformly dispersed. Moreover, wiredrawn materials (wire diameter φ 0.2 mm) of Samples of No. 1-1 to No. 1-9 produced from such aged materials are all considered as substantially maintaining the structure in which fine precipitates (here, with an average particle size of 200 nm or less) are uniformly dispersed, namely the structure of the aged materials.

One of the reasons why all of the copper alloy wires of Sample No. 1-1 to Sample No. 1-9 have a high electrical conductivity, a high strength, and a high toughness is considered as the fact that a compound containing Mg and P was precipitated (improvement of the electrical conductivity), the effect of improving the strength through dispersion strengthening (precipitation strengthening) was achieved (improvement of the strength), and the precipitate was extremely fine and uniformly dispersed and less likely to become an origin of a crack (improvement of the toughness). Further, in consideration of the manufacturing conditions, one of the reasons is considered as the fact that the effect of improving the strength based on work hardening through wiredrawing in multiple passes was achieved (improvement of the strength), the intermediate softening treatment was performed during the wiredrawing (improvement of the toughness, improvement of the electrical conductivity), and the intermediate softening treatment was performed at an appropriate timing (the timing when the intermediate wire diameter was relatively small) (suppression of deterioration of the strength due to the softening treatment).

It is seen that a copper alloy wire having a high electrical conductivity, a high strength, and a high toughness as described above can be manufactured in the follow way. Namely, a solid solution is produced first, aging is separately performed, and thereafter wiredrawing is performed in multiple passes while the softening treatment is performed at an appropriate timing during the wiredrawing. Here, elongation is enhanced by annealing after wiredrawing. The tensile strength after annealing is 400 MPa or more. It is seen that a sufficiently high strength is maintained while the elongation is enhanced. In view of this, the wire can be considered as having a tensile strength of more than 400 MPa before annealing. Accordingly, it is considered that in the case where a wiredrawn material having been drawn to have the final wire diameter has a sufficiently high elongation (an elongation at breakage of not less than 5%), annealing may be skipped so that the copper alloy wire having a still higher strength can be obtained.

In contrast, it is seen that the sample failing to have the aforementioned specific composition, specifically Sample No. 1-101 having an excessively high content of Mg, has an excessively low electrical conductivity. A reason for this is considered as the large amount of dissolved Mg. As for Sample No. 1-102 in which the Mg content is too low and the P content is too high and Sample No. 1-103 in which the P content is too high, it is seen that the elongation is 10% while the strength is low. A reason for this is considered as the fact that the excessively high P content causes precipitates containing Mg to be excessively precipitated or particles are likely to grow to bulky particles, accordingly elongation is difficult to increase by annealing, and a sufficient softening treatment becomes necessary to keep an elongation of 10%. As a result the strength was reduced. In order to increase the elongation of a material in which excessive precipitation occurs or which has bulky precipitate particles, softening at a still higher temperature or long-time softening is considered as necessary. However, softening performed under such a condition causes reduction of the strength. Thus it is difficult to achieve well-balanced high elongation and high strength. Moreover, the material in which the excessive precipitation occurs or in which bulky precipitate particles are present is also considered as inferior in wiredrawing property. As to Sample No. 1-104 in which the Mg content is relatively high and the P content is excessively high, breakage occurred during wiredrawing. Therefore, the tensile strength, the elongation at breakage, and the electrical conductivity were not measured. A reason why breakage occurred is considered as the fact that the too high content of Mg and the too high content of P, and bulky precipitates become easier to be generated. Thus, a crack originated from a bulky particle is more likely to occur.

The copper alloy wires of Samples of No. 1-1 to No. 1-9 produced for Test Example 1 are all excellent in electrical conductivity, high in strength, and also excellent in elongation as described above, and considered as having properties (electrical conductivity, strength necessary for exhibiting a preferred terminal-fixing strength and anti fatigue property, elongation necessary for exhibiting preferred flexural property and impact resistance) desired for an electric wire for an automobile, or a terminal-fitted electric wire for an automobile, for example. Accordingly, the above-described copper alloy wire, copper alloy stranded wire made up of the copper alloy wires, or a compressed wire produced by further compressing the copper alloy wires, is expected to be suitably used as a conductor of an electric wire for an automobile.

### Test Example 2

A copper alloy wire was produced through a manufacturing process, namely the following Process A or Process B, and the properties (tensile strength, elongation at breakage, electrical conductivity) as well as the average particle size of the matrix of the obtained copper alloy wire were examined.

Process A: casting (wire diameter φ 9.5 mm)→stripping (wire diameter φ 8 mm)→wiredrawing (wire diameter φ 2.6 mm)→aging precipitation (batch system)→wiredrawing (wire diameter φ 0.45 mm)→intermediate softening (batch system)→wiredrawing (wire diameter φ 0.32 mm or wire diameter φ 0.16 mm)→final softening (batch system)

Process B: casting (wire diameter φ 12.5 mm)→conform (wire diameter φ 8 mm)→wiredrawing (wire diameter φ 0.32 mm)→intermediate softening (continuous system)→wiredrawing (wire diameter φ 0.16 mm)→final softening (continuous system)

Process A is now described specifically. First, as raw materials, electrolytic copper having a purity of 99.99% or more and additive elements shown in Table 2 were prepared, placed in a high-purity carbon crucible and vacuum-melted. Thus, a molten alloy having the composition shown in Table 2 was produced. At this time, the surface of the molten alloy was sufficiently covered with charcoal chips so that the surface of the molten alloy did not contact the atmosphere. The obtained molten alloy mixture and a high-purity carbon mold were used and in accordance with the upward continuous casting method (upcast method), a cast material having a circular cross section was produced. The obtained cast material was subjected stripping and wiredrawing until a wire diameter of φ 2.6 mm was reached. Subsequently, the wiredrawn material was subjected to an aging treatment under the condition of 450° C.×8 hours. Thus, an aged material was produced. The aged material was subjected to wiredrawing in multiple passes. Thus, a wiredrawn material was produced. Here, on an intermediate material obtained through wiredrawing which was done until a wire diameter of φ 0.45 mm was reached, an intermediate softening treatment was performed under the condition of 450° C.×one hour. After this intermediate softening treatment, wiredrawing was performed. Thus, a wiredrawn material having a final wire diameter of φ 0.32 mm or 0.16 mm was produced. On the obtained wiredrawn material, a final softening treatment (batch system) was performed under the conditions shown in Table 2. Accordingly, a copper alloy wire was obtained.

Process B is now described specifically. First, as raw materials, electrolytic copper having a purity of 99.99% or more and additive elements shown in Table 2 were prepared, placed in a high-purity carbon crucible and vacuum-melted. Accordingly, a molten alloy having the composition shown in Table 2 was produced. At this time, the surface of the molten alloy was sufficiently covered with charcoal chips so that the surface of the molten alloy did not contact the atmosphere. The obtained molten alloy mixture and a high-purity carbon mold were used and in accordance with the upward continuous casting method (upcast method), a cast material having a circular cross section was produced. The obtained cast material was subjected the conform process and wiredrawing until a wire diameter of φ 0.32 mm was reached. In the conform process, both the aging precipitation and working are performed. Subsequently, the wiredrawn material was subjected to an intermediate softening treatment under the condition of 450° C.×one hour. After this intermediate softening treatment, wiredrawing was performed until a wire diameter of φ 0.16 mm was reached. Thus, a wiredrawn material having the final wire diameter φ 0.16 mm was produced. On the obtained wiredrawn material, continuous final softening treatment was performed. Accordingly a copper alloy wire was obtained.

Regarding the obtained copper alloy wire, the tensile strength (MPa), the elongation at breakage (%), and the electrical conductivity (% IACS) at room temperature were examined in a similar way to Test Example 1. Further, the average particle size of the matrix was examined in the following way. First, a cross section was subjected to a treatment by a cross section polisher (CP), and the cross section was observed with a scanning electron microscope (SEM). The area of any observed range is divided by the number of particles present in this range. The diameter of a circle corresponding to the area, which is the quotient of the above division, is the average crystal particle size. It should be noted that the observed range is a range in which 50 or more particles are present, or the whole cross section.

The results are shown in Table 2.

TABLE 2

| | | | | | | | | | | | | average |
|---|---|---|---|---|---|---|---|---|---|---|---|---|
| | | | | | | | heat treatment | | properties | | | crystal |
| | composition | | | | manu- | wire | conditions | | tensile | elonga- | electrical | particle |
| Sample | (wt %) | | | | facture | diameter | temperature | time | strength | tion | conductivity | size |
| No. | Cu | Mg | P | Mg/P | process | (mm) | (° C.) | (h) | (MPa) | (%) | (% IACS) | (μm) |
| 2-1 | Bal. | 0.21 | 0.025 | 8.4 | A | 0.16 | 350 | 1 | 450 | 6 | 81 | 0.9 |
| 2-2 | Bal. | 0.39 | 0.020 | 19.5 | A | 0.16 | 400 | 1 | 485 | 9 | 71 | 1.7 |
| 2-3-1 | Bal. | 0.42 | 0.039 | 10.8 | A | 0.16 | 300 | 8 | 495 | 9 | 72 | 1.0 |
| 2-3-2 | | | | | B | 0.16 | continuous softening | | 520 | 9 | 69 | 0.6 |
| 2-4 | Bal. | 0.04 | 0.080 | 0.5 | A | 0.32 | 300 | 1 | 510 | 9 | 73 | 0.8 |
| 2-5 | Bal. | 0.06 | 0.020 | 3.1 | A | 0.16 | 300 | 1 | 540 | 8 | 65 | 0.7 |
| 2-6-1 | Bal. | 0.06 | 0.060 | 1.0 | A | 0.32 | 300 | 1 | 560 | 8 | 65 | 0.6 |
| 2-6-2 | | | | | B | 0.16 | continuous softening | | 580 | 9 | 62 | 0.4 |
| 2-7 | Bal. | 0.06 | 0.075 | 0.8 | A | 0.16 | 300 | 1 | 580 | 7 | 65 | 0.5 |
| 2-8 | Bal. | 0.77 | 0.081 | 9.5 | A | 0.32 | 300 | 1 | 605 | 7 | 60 | 0.5 |
| 2-101 | Bal. | 1.15 | 0.080 | 14.4 | A | 0.16 | 400 | 1 | 600 | 10 | 46 | 0.8 |
| 2-102 | Bal. | 0.15 | 0.025 | 6.0 | A | 0.16 | 300 | 1 | 380 | 10 | 88 | 2.1 |
| 2-103 | Bal. | 0.21 | 0.009 | 23.3 | A | 0.16 | 300 | 1 | 390 | 8 | 8 | 1.0 |
| 2-104 | Bal. | 0.79 | 0.150 | 5.3 | A | working impossible | | | | | | |
| 2-105 | Bal. | 0.19 | 0.062 | 3.1 | A | 0.16 | 300 | 8 | 460 | 5 | 75 | 0.4 |

| | | | | | | | | | | | |
|---|---|---|---|---|---|---|---|---|---|---|---|
| 2-106 | Bal. | 0.85 | 0.019 | 44.7 | B | 0.16 | continuous softening | 560 | 8 | 55 | 0.5 |

As shown in Table 2, it is seen that Samples of No. 2-1 to No. 2-8 containing not less than 0.2% by mass and not more than 1% by mass of Mg and not less than 0.02% by mass and not more than 0.1% by mass of P, and having an average particle size of the matrix of not less than 10 μm are all excellent in electrical conductivity, high in strength, and also excellent in elongation. Specifically, Samples of No. 2-1 to No. 2-8 all have an electrical conductivity of not less than 60% IACS, a tensile strength of not less than 400 MPa (here, not less than 450 MPa), and an elongation at breakage of not less than 5% (here, not less than 6%).

In contrast, it is seen that the sample which does not have the above-described specific composition, specifically Sample No. 2-101 with an excessive Mg content, has an excessively low electrical conductivity. It is seen that Sample No. 2-102 with an excessively low Mg content and sample No. 2-103 with an excessively low P content have a low strength. It is seen that Sample No. 2-103 is also excessively low in electrical conductivity. As for Sample No. 2-104 in which the Mg content is relatively high while the P content is excessively high, breakage occurred during wiredrawing. Therefore, the tensile strength, the elongation at breakage, and the electrical conductivity were not measured. It is seen that Sample No. 2-105 in which the Mg content is low and Mg/P is 3.1 is small in elongation. It is seen that Sample No. 2-106 in which the P content is low and Mg/P is 44.7 is low in electrical conductivity.

### Test Example 3

A copper alloy stranded wire was produced through a manufacturing process, namely the following Process A′ or Process B′, and the properties (terminal-fixing strength, impact resistance) of the obtained copper alloy stranded wire were examined.

A′: wiredrawing (wire diameter φ 0.16) of a copper alloy wire in Process A of Test Example 2→compressed stranded wire (7 wires)→batch softening or continuous softening→insulation extrusion (cross-sectional area: 0.13 mm²)

B′: wiredrawing (wire diameter φ 0.16) of a copper alloy wire in Process B of Test Example 2→compressed stranded wire (7 wires)→continuous softening→insulation extrusion (cross-sectional area: 0.13 mm²)

Process A′ is specifically described. First, as a copper alloy wire, the copper alloy wire produced through Process A of Test Example 2 was prepared. The obtained copper alloy wire was subjected to wiredrawing until a wire diameter of φ 0.16 mm was reached. Seven wiredrawn materials thus obtained were stranded together into a stranded wire. On the stranded wire, a softening treatment was performed under the softening conditions shown in Table 3. Accordingly a copper alloy stranded wire was obtained. On the copper alloy wire, insulation extrusion was performed. For the insulation extrusion, polyvinyl chloride (PVC) with a thickness of 0.2 mm was extruded on the surface of the copper alloy wire. The cross sectional area of the copper alloy stranded wire after the insulation extrusion was 0.13 mm².

Process B′ is specifically described. First, as a copper alloy wire, the copper alloy wire produced through Process B of Test Example 2 was prepared. The obtained copper alloy wire was subjected to wiredrawing until a wire diameter of φ 0.16 mm was reached. Seven wiredrawn materials thus obtained were stranded together into a stranded wire. On the stranded wire, a continuous softening treatment was performed. Thus, a copper alloy stranded wire was obtained. On the copper alloy wire, insulation extrusion was performed. For the insulation extrusion, polyvinyl chloride (PVC) with a thickness of 0.2 mm was extruded on the surface of the copper alloy wire. The cross-sectional area of the copper alloy stranded wire after the insulation extrusion was 0.13 mm².

For the obtained copper alloy wire, the terminal-fixing strength and the impact resistance at room temperature were examined.

The terminal-fixing strength (N) was measured through the following procedure. First, an insulating coating layer at an end of a covered electric was stripped away to expose the stranded wire. To the exposed stranded wire, a terminal portion was press-fit. With a general-purpose tensile tester, the terminal portion was pulled at 100 mm/min. At this time, the maximum load (N) under which the terminal portion was not pulled off was measured, and this maximum load was defined as the terminal-fixing strength (N).

The impact resistance was calculated through the following procedure. A weight was attached to the leading end of a covered electric wire (point to point distance: 1 m), the weight was lifted by 1 m and thereafter allowed to fall freely. At this time, the maximum weight (kg) of the weight under which breakage of the covered electric wire did not occur was measured, and the product of this weight and the gravitational acceleration (9.8 m/s²) and the fall distance was divided by the fall distance. The resultant quotient was defined as the impact resistance (J/m or (N/m)/m) and evaluated.

The results are shown in Table 3.

TABLE 3

| | | | | | | | | properties | |
|---|---|---|---|---|---|---|---|---|---|
| | | | | | | heat treatment | | terminal- | |
| | composition | | | | manu- | conditions | | fastening | impact |
| Sample | (mass %) | | | | facture | temperature | time | strength | resistance |
| No. | Cu | Mg | P | Mg/P | process | (° C.) | (h) | (N) | (J/m) |
| 3-1 | Bal. | 0.21 | 0.025 | 8.4 | A′ | 350 | 1 | 52 | 5 |
| 3-2 | Bal. | 0.39 | 0.020 | 19.5 | A′ | 350 | 1 | 54 | 6 |
| 3-3-1 | Bal. | 0.42 | 0.039 | 10.8 | A′ | 300 | 8 | 55 | 7 |
| 3-3-2 | | | | | B′ | continuous softening | | 58 | 6 |
| 3-4 | Bal. | 0.04 | 0.080 | 0.5 | A′ | 300 | 1 | 57 | 6 |
| 3-5 | Bal. | 0.06 | 0.020 | 3.1 | A′ | 300 | | 62 | 6 |
| 3-6-1 | Bal. | 0.06 | 0.060 | 1.0 | A′ | 300 | 1 | 62 | 6 |
| 3-6-2 | | | | | B′ | continuous softening | | 64 | 7 |
| 3-7 | Bal. | 0.06 | 0.075 | 0.8 | A′ | 300 | 1 | 63 | 6 |
| 3-8 | Bal. | 0.77 | 0.081 | 9.5 | A′ | 300 | 1 | 68 | 6 |
| 3-101 | Bal. | 1.15 | 0.080 | 14.4 | A′ | 400 | 1 | 66 | 7 |
| 3-102 | Bal. | 0.15 | 0.025 | 6.0 | A′ | 300 | 1 | 41 | 4 |
| 3-103 | Bal. | 0.21 | 0.009 | 23.3 | A′ | 300 | 4 | 42 | 4 |
| 3-105 | Bal. | 0.19 | 0.062 | 3.1 | A′ | 300 | 8 | 50 | 4 |

| | | | | | | | | |
|---|---|---|---|---|---|---|---|---|
| 3-106 | Bal. | 0.85 | 0.019 | 44.7 | B′ | continuous softening | 62 | 4 |

As shown in Table 3, it is seen that Samples of No. 3-1 to No. 3-8 containing not less than 0.2% by mass and not more than 1% by mass of Mg and not less than 0.02% by mass and not more than 0.1% by mass of P and having an average particle size of the matrix of not less than 10 μm are all excellent in terminal-fixing strength and impact resistance.

### INDUSTRIAL APPLICABILITY

The terminal-fitted electric wire of the present invention and the electric wire of the present invention can suitably be used for a variety of wires, particularly a wire for an automobile. The copper alloy wire of the present invention and the copper alloy stranded wire of the present invention can suitably be used for conductors of a variety of electric wires, particularly a conductor of an electric wire for an automobile. The method of manufacturing a copper alloy wire of the present invention can suitably be used for manufacture of a copper alloy wire.

### REFERENCE SIGNS LIST

1 copper alloy wire; 10, 10A copper alloy stranded wire; 10B copper alloy stranded wire (compressed wire); 20 electric wire; 21 conductor; 23 insulating layer; 30 terminal portion; 32 fit portion; 34 wire barrel portion; 36 insulation barrel portion; 40 terminal-fitted electric wire; 100, 100B constituent wire

1. A copper alloy wire comprising: not less than 0.2% by mass and not more than 1% by mass of Mg; not less than 0.02% by mass and not more than 0.1% by mass of P; and the balance containing Cu and inevitable impurities,
the copper alloy wire having
an electrical conductivity of not less than 60% IACS,
a tensile strength of not less than 400 MPa, and
an elongation at breakage of not less than 5%.

2. The copper alloy wire according to claim 1, wherein
the copper alloy wire has a structure in which a precipitate disperses,
the precipitate includes a compound containing the Mg and the P, and
the precipitate has an average particle size of not more than 500 nm.

3. The copper alloy wire according to claim 1, further comprising: not less than 0.01% by mass and not more than 0.5% by mass in total of at least one element selected from Fe, Sn, Ag, In, Sr, Zn, Ni, and Al.

4. The copper alloy wire according to claim 1, wherein a mass ratio Mg/P of the Mg to the P is not less than 4 and not more than 30.

5. The copper alloy wire according to claim 1, wherein the copper alloy wire has a wire diameter of not more than 0.35 mm.

6. The copper alloy wire according to claim 1, wherein an average particle size of a matrix including the Cu is not more than 10 μm.

7. A copper alloy stranded wire comprising the copper alloy wire as recited in claim 1.

8. A copper alloy stranded wire which is a compression-molded stranded wire comprising the copper alloy wire as recited in claim 1.

9. The copper alloy stranded wire according to claim 7, wherein the copper alloy stranded wire has a cross-sectional area of not less than 0.05 mm² and not more than 0.5 mm².

10. The copper alloy stranded wire according to claim 7, wherein the copper alloy stranded wire has a twist pitch of not less than 10 mm and not more than 20 mm.

11. An electric wire comprising a conductor and an insulating layer covering a surface of the conductor,
the conductor being a copper alloy wire as recited in claim 1.

12. An electric wire with a terminal comprising the electric wire as recited in claim 11 and the terminal attached to an end of the electric wire.

13. A method of manufacturing a copper alloy wire, the method comprising:
dissolving Mg and P into Cu to prepare a solid solution material having a composition containing not less than 0.2% by mass and not more than 1% by mass of the Mg; not less than 0.02% by mass and not more than 0.1% by mass of the P; and the balance containing the Cu and inevitable impurities;
precipitating a compound containing the Mg and the P to disperse the compound in a matrix by heating the solid solution material to produce an aged material; and
wiredrawing the aged material in a plurality of passes to produce a wiredrawn material having a predetermined final wire diameter, an electrical conductivity of not less than 60% IACS, and a tensile strength of not less than 400 MPa,
in the wiredrawing, an intermediate softening treatment being performed on an intermediate material having an intermediate wire diameter of more than one time and not more than ten times as large as the final wire diameter.

14. The method of manufacturing a copper alloy wire according to claim 13, wherein the solid solution material is produced by casting a copper alloy having the composition and performing a solution heat treatment on the cast copper alloy.

15. The method of manufacturing a copper alloy wire according to claim 13, wherein the aged material is produced by performing an aging treatment on the solid solution material.

16. The method of manufacturing a copper alloy wire according to claim 13, further comprising annealing on the wiredrawn material to cause the annealed wiredrawn material to have an elongation at breakage of not less than 5%.

17. An electric wire comprising a conductor and an insulating layer covering a surface of the conductor,
the conductor being a copper alloy stranded wire as recited in claim 7.
